(19) United States
(12) Patent Application Publication
(10) Pub. No.: US 2019/0250968 A1
(43) Pub. Date: Aug. 15, 2019

(54) Smart Multiple Display Calculator with Input Output Data Matrix

(71) Applicants: Alireza Bemanian, Monee, IL (US); Amin Bemanian, Wauwatosa, WI (US)

(72) Inventors: Alireza Bemanian, Monee, IL (US); Amin Bemanian, Wauwatosa, WI (US)

(21) Appl. No.: 14/668,238

(22) Filed: May 26, 2015

(51) Int. Cl. G06F 11/07; G06F 3/0482; G06F 3/0485; G06F 3/0481; G06F 17/24; G06F 3/0484

(52) U.S. Cl. CPC G06F 11/0706; G06F 11/0751; G06F 11/079; G06F 3/04845; G06F 3/0485; G06F 3/04817; G06F 17/246; G06F 3/0482

(57) ABSTRACT

A software device to perform math calculations upon numerical or data expressions entries, and capable of coordinating multiple data entries, displays, and storage operations. The package is consisted of dual entry inputs, a single result display, single arithmetic expression display for each entry, and a data spreadsheet matrix which is constantly synchronized with data entries and result contents. The data/arithmetic inputs are entered via the software device control buttons, computer keyboard, software device memory buttons, saved user prior transaction files, the software device entry/result history buttons, or a cut and paste process within the various package displays or external software tools such as Microsoft Office Word and Excel. The software device provides error checking schemes for any type of the above mentioned entry methods in combination with its operation merit monitoring schemes, FIGS. 1 through 21.

### TECHNICAL FIELD

The software device is suited for calculations requiring insertion of arithmetic expressions in text format, data entry via text or graphical user interface control buttons, or real time calculations performed by a matrix grid where each matrix row is treated as an independent entity with full editing and instant computational capabilities. Coordination and synchronization of the entries and result text boxes with the matrix is performed automatically on the fly for an inserted set of entries or alterations to the package inputs, when all require instant calculations at the end of each data/expression entry.

### BACKGROUND

The use of calculators had been of interest to a diverse group of end users. This software device had taken shape by the inventors' original concepts started in the year 2000 and based on the need for a multiple entry/display device to provide ease of use and navigation throughout the vast amount of data gathered within a computational session. Explicitly by focusing on the intuitive user interactions eased with the use of graphical user interfaces, combined by the ability to deploy mathematical expressions as allowable entries to the device.

The ongoing efforts led to the use of data/expression matrix as a part of the software device expansion to broaden such data visualization, and then on the evolving idea to make coordination and dynamic interactions possible between the varied entities within the package.

### SUMMARY

Accordingly, the need for a calculator device capable of displaying and manipulating the entries independently was the initial objective by the inventors. This enables the capture of mathematical operation in a snapshot and not to require additional separate recording of the performed steps, or added retrieval methods.

At the time the concept required some try and error approaches to shape the foundations for coordinating the multiple input entry mechanisms and the independent result exhibitions, and to have the embedded device automation methods to adjust applicable runtime priority on each entry media.

This evolving process which started from the year 2000 matured itself by merging with the emerging needs to allow insertion of the basic mathematical expressions into the entry medias, and later on starting from year 2005, addition of a data/expression matrix containers to directly record and display the two entries and result text boxes contents, where each container matrix row gets allocated to a single mathematical calculation, and the synchronization between all these involved medias are performed independently.

In accordance with these defined needs and requirements new features were sequentially added to include, configuration of the data matrix as an autonomous computational device. In the sense, that the entry cells within each matrix row be editable to contain the desired data or expressions, and to provide computational and display of the results at each instant that the matrix cell entries or cell edit session is ended, all to take place implicitly on real time bases.

As a result, each computational stage via the core calculator panel is instantly added as a new row to the data matrix, the cells or/and rows are selectable to be copied, cut, or pasted either within the data matrix or the external applications as Microsoft Word or Excel, the data matrix cell contents are searchable or replaceable, the data matrix contents are savable or retrievable by the use of specially formatted flat files, group calculations or manipulations within the entries or results columns are attainable by the use of dynamically selected Record Session control buttons and a pop up display tailored to the selected task, and the data matrix provides a Redo/Undo scheme to replace the matrix cell contents from a current to prior values, or vice versa.

In accordance with these evolving concepts a set of new features were concurrently added to include instant data funneling from the attained results into a selected entry media, implementation of Undo/Redo schemes for each of the two entries and result panels, each deployable independently, storage of core calculation steps and any of the desired two entries and/or result and their retrieval based on an indexing method, ease of positioning or moving the data/expression insertion point within or between the two core entry panels all via core calculator dashboard control panel, and error exhibition methods to cease the calculation or warn the user of the incurred error either by altering the fore and background color of the erroneous media or/and additional popup windows to provide information of how to correct the error.

In accordance with these concepts the Core Calculator dashboard was further evolved to contain the allowed mathematical operators within an entry expression all implementable by the control buttons. The deployed buttons insert such operators within the two core input entry panels or the data matrix elements when the tracking software intuitively is aware to position the operators accordingly. This evolved coordination and synchronization between the above expressed data medias and the inferring acts by the software to perform in full coordination with the user intent makes the device smart enough to attain the majority of such tasks in background and be prepared for the forthcoming actions at each operational instance.

FIGURES and DRAWINGS

| | |
|---|---|
| Figure 1 The software device graphical user interface, entries addition | Drawings Page 1 |
| Figure 2 The software device graphical user interface, entries power | Drawings Page 2 |
| Figure 3 The software device graphical user interface, square operators | Drawings Page 3 |
| Figure 4 The software device graphical user interface, square root operators | Drawings Page 4 |
| Figure 5 The software device graphical user interface, power operators | Drawings Page 5 |
| Figure 6 The software device graphical user interface, inverse operators | Drawings Page 6 |
| Figure 7 The software device graphical user interface, remainder operators | Drawings Page 7 |
| Figure 8 The software device graphical user interface, percentage operators | Drawings Page 8 |
| Figure 9 The software device graphical user interface, absolute value operators | Drawings Page 9 |
| Figure 10 The software device graphical user interface, E2 computational history | Drawings Page 10 |
| Figure 11 The software device graphical user interface, E1 computational history | Drawings Page 11 |
| Figure 12 The software device graphical user interface, result computational history | Drawings Page 12 |
| Figure 13 The software device graphical user interface, data matrix mode active | Drawings Page 13 |
| Figure 14 The software device graphical user interface, data matrix mode active | Drawings Page 14 |
| Figure 15 The software device graphical user interface, data matrix mode, resized | Drawings Page 15 |
| Figure 16 The software device graphical user interface, data matrix Mode, E1 Display | Drawings Page 16 |
| Figure 17 The software device graphical user interface, data matrix mode, E2 Display | Drawings Page 17 |
| Figure 18 The software device graphical user interface, data matrix mode, Rs Display | Drawings Page 18 |
| Figure 19 The software device graphical user interface, Reminder Flashing, Operator | Drawings Page 19 |
| Figure 20 The software device graphical user interface, Reminder Flashing, Memory | Drawings Page 20 |
| Figure 21 The software device graphical user interface, Reminder Flashing, Rs | Drawings Page 21 |
| Figure 22 The software device Graphical User Interface software interactions | Drawings Page 22 |
| Figure 23 The software device top user controlled components | Drawings Page 23 |
| Figure 24 The software device service components | Drawings Page 24 |
| Figure 25 The software device Core service components | Drawings Page 25 |
| Figure 26 Copy Cut Paste top layer processes | Drawings Page 26 |
| Figure 27 Mapping from Clipboard | Drawings Page 27 |
| Figure 28 Retrieve of the Paste Map Content | Drawings Page 28 |
| Figure 29 Paste with data matrix cell selected sub process | Drawings Page 29 |

### BRIEF DESCRIPTION OF FIGURES AND DRAWINGS

“The patent or application file contains at least one dewing executed in color. Copies of this patent or patent application publication with color drawing(s) will be provided by the office upon request and payment of the necessary fee.”

This is a concise description of the individual items tabulated by the preceding section, to provide a snapshot detail of each presented sketch. Namely, to further clarify the software device embodiment The drawings in gray scale and their counterparts in color are provided as exact duplicates of each other with the only exception of gray scale versus color drawing exhibition, which has facilitated the use of their identical figure designators as the list of Figures and Drawings enlisted by the previous section

FIG. 1: The snapshot exhibits the highlight of one of the arithmetic operators enacting on entries 1 and 2, with the attained calculations result, shown within the Result panel. This includes the concurrent update made to the entries and result descriptions exhibited at the left top corner of each display panel.

FIG. 2: The snapshot exhibits one of the multifaceted operators, enacting on both entries E1 and E2, with the result presented by the Result panel, namely E2 to the power of E1. The computed results for each individually entered mathematical expression and the result are accordingly shown, placed at the top left corner of each display panel.

FIG. 3: The snapshot exhibits the types of graphically selectable square operators. They are selectable as the core calculator prime operators, or they could equally be deployed by their text symbols in arithmetic expressions within either the entry panels or the Data Matrix cells, if the Record Session is active.

FIG. 4: The snapshot exhibits the types of graphically selectable square root operators. They are selectable as the core calculator prime operators, or they could equally be deployed by their text symbols in arithmetic expressions within either the entry panels or the Data Matrix cells, if the Record Session is active.

FIG. 5: The snapshot exhibits the types of graphically selectable power operators. They are selectable as the core calculator prime operators, or they could equally be deployed by their text symbols in arithmetic expressions within either the entry panels or the Data Matrix cells, if the Record Session is active.

FIG. 6: The snapshot exhibits the types of graphically selectable inverse operators. They are selectable as the core calculator prime operators, or they could equally be deployed by their text symbols in arithmetic expressions within either the entry panels or the Data Matrix cells, if the Record Session is active.

FIG. 7: The snapshot exhibits the types of graphically selectable modulus operators. They are selectable as the core calculator prime operators, or they could equally be deployed by their text symbols in arithmetic expressions within either the entry panels or the Data Matrix cells, if the Record Session is active.

FIG. 8: The snapshot exhibits the types of graphically selectable percentage operators. They are selectable as the core calculator prime operators, or they could equally be deployed by their text symbols in arithmetic expressions within either the entry panels or the Data Matrix cells, if the Record Session is active.

FIG. 9: The snapshot exhibits the types of graphically selectable absolute operators. They are selectable as the core calculator prime operators, or they could equally be deployed by their text symbols in arithmetic expressions within either the entry panels or the Data Matrix cells, if the Record Session is active.

FIG. 10: The snapshot exhibits access to prior entered entities combined with the user ability to depict any of the instances via the click of the mouse pointed to the desired element, E2 History.

FIG. 11: The snapshot exhibits access to prior entered entities combined with the user ability to depict any of the instances via the click of the mouse pointed to the desired element, E1 History.

FIG. 12: The snapshot exhibits access to prior entered entities combined with the user ability to depict any of the instances via the click of the mouse pointed to the desired element, Result History.

FIG. 13: The snapshot is to provide a glance at the software device with a Record Session active mode of operation. In this mode any core computation would simultaneously be inserted as a single new row within the data matrix.

FIG. 14: The snapshot is to present the data matrix mechanism during an active Record Session, where each single matrix row has autonomous computational capabilities as recipient of both entries and the operator. New empty rows could be added and populated independent of the entries which have already taken place as the result of core computations.

FIG. 15: The snapshot is to present the software device capability to be resized in both horizontal and vertical positions as desired. If required, with both horizontal and vertical scroll bars to view the data matrix elements in their entirety.

FIG. 16: The snapshot is to exhibit the software device data matrix computations to be performed on entry 1 column cells in their entirety, and displayed by a properly enabled data field on real time.

FIG. 17: The snapshot is to exhibit the software device data matrix computations to be performed on entry 2 column cells in their entirety, and displayed by a properly enabled data field on real time.

FIG. 18: The snapshot is to exhibit the software device data matrix computations to be performed on Result column cells in their entirety, and displayed by a properly enabled data field on real time.

FIG. 19: The snapshot is to exhibit Core Calculator dynamic operators flashing arrow, to be remained on the control button before the dropout operators list is shown. The arrow remains visible for a limited time duration to remind the user of the additional operators,

FIG. 20: The snapshot is to exhibit Core Calculator dynamic operators flashing line, to be remained on the memory storage, memory clear, memory increment, memory decrement, or recall control button reminding the operator of the steps to follow to complete a memory panel process. The process shall terminate if the following steps are not undertaken by the user within a fixed time length.

FIG. 21: The snapshot is to exhibit the Record Session dynamic operators flashing arrow, to be remained on the control button before the dropout operators list is shown. The arrow remains visible for a limited time duration to remind the user of the additional operators.

FIG. 22: The drawing is to exhibit the software device core elements and their interaction with the periphery software layers implemented by the graphical user interface, GUI.

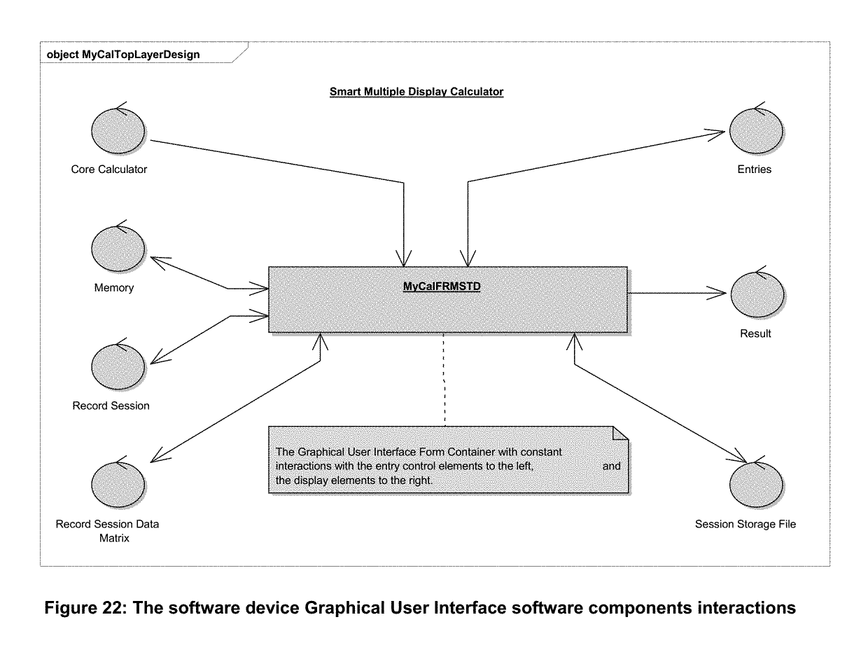

FIG. 23: The drawing is to exhibit the software device core components interactions to include control button elements, menu entities, copy cut paste processes, input output displays, input output object collections, and the control structures.

FIG. 24: The drawing is to exhibit the software device components interactions to include drag and drop process, mouse events manager, parser components, threads, undo redo components, and utility objects.

FIG. 25: The drawing is to exhibit the software device core components interactions to include file storage dialogs and processes, fault exception handler, history components, record session processes, calculation engine, and the user interaction history data base elements.

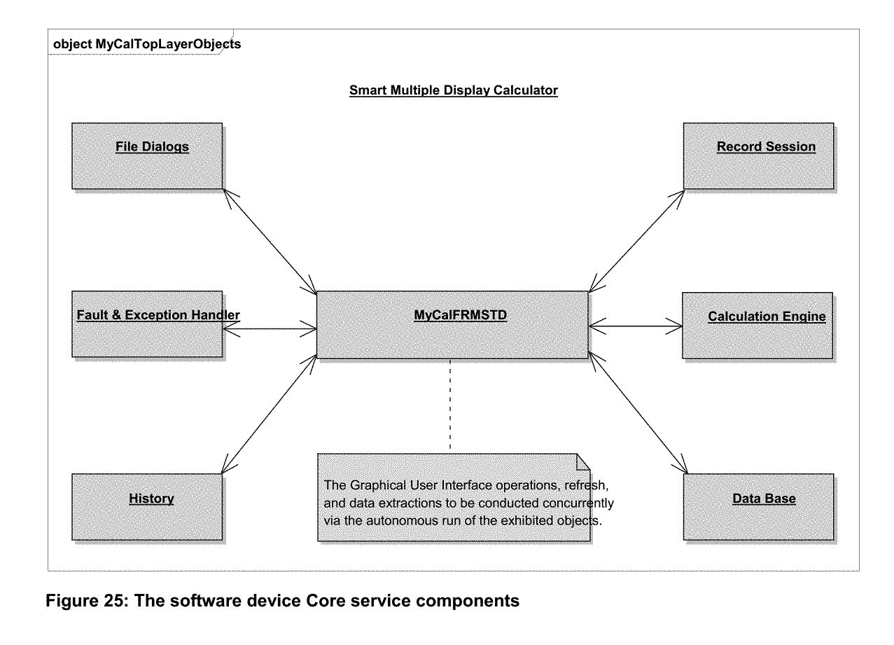

FIG. 26: The drawing is to exhibit the software device Copy Cut Paste layer processes enabling the data repositioning or transfer within data matrix segments, or interactions with external compatible spreadsheets as Microsoft Excel.

FIG. 27: The drawing is to exhibit the software device clipboard content deployment as an intermediary/transitional media facilitating the interactions with external software tools.

FIG. 28: The drawing is to exhibit the software device capability in processing the mapped copied data and its transformation to attain the paste operations.

FIG. 29: The drawing is to exhibit the software device processing of the data matrix selected cells and the inference to align and match the selected cells pattern with the paste data map.

### DESCRIPTION OF EMBODIMENTS

Described below are the software elements and components constituting the smart multiple display calculator referred to as the “software device”, in combination with their behaviors and dynamics to warrant the required synchronization and updates essential to proper functioning and coordination of the device, and entailed to servicing varied input and output sources.

The software device is architected based on the services and interactions within key software components and objects at the very top layer. This is to provide proper services or communicational objects between the noted entities and their elements in an orchestrated and managed approach. Namely to provide boundaries and interfaces for the type of exposed or internal services, governed by the depicted top layer overall role and classifications, and their lower level exposed services. In general this is accomplished by accessible methods as wrapper functions, functional entities to access or retrieve their related objects data, or manipulators for such data objects. This is a focal point to refer to the transactions within the software cores either as services or interaction throughout this section.

The need for the invoked services to take place in an applicable timely pattern, and their behaviors to furnish the required chain sequences capable of refreshing the multiple display panels and the data grid elements, or to extract and gather input data or computed results, are made possible by relying on independent threads, software timer services, and the events generated and serviced primarily by the host platform operating system. These services will accordingly be called by the aforementioned terms within the patent application.

The software device graphical user interface provides the tools required by the user to utilize the software device in its entirety, and is attained by dedicating data entries and result gathering tasks directly to the graphical user interface. This has been implemented by focusing on and categorizing the types of the user requests, and to dynamically shape the graphical user interface to fulfill such calls.

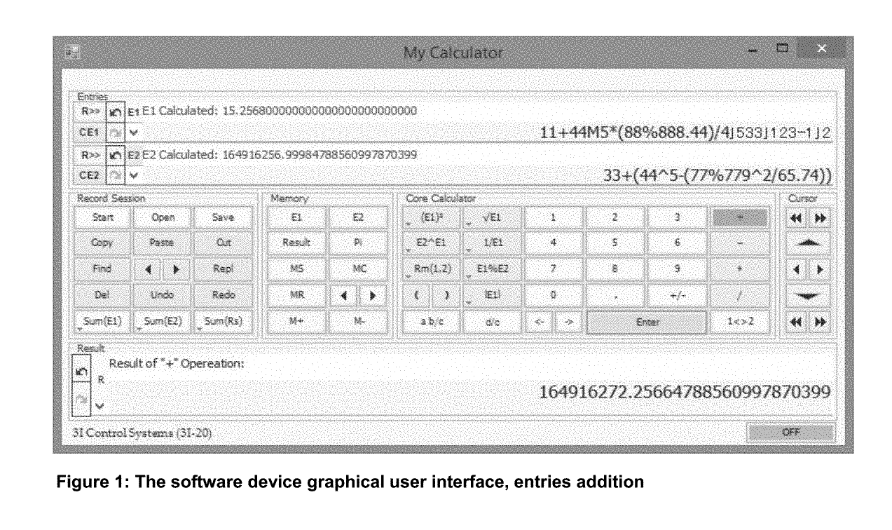

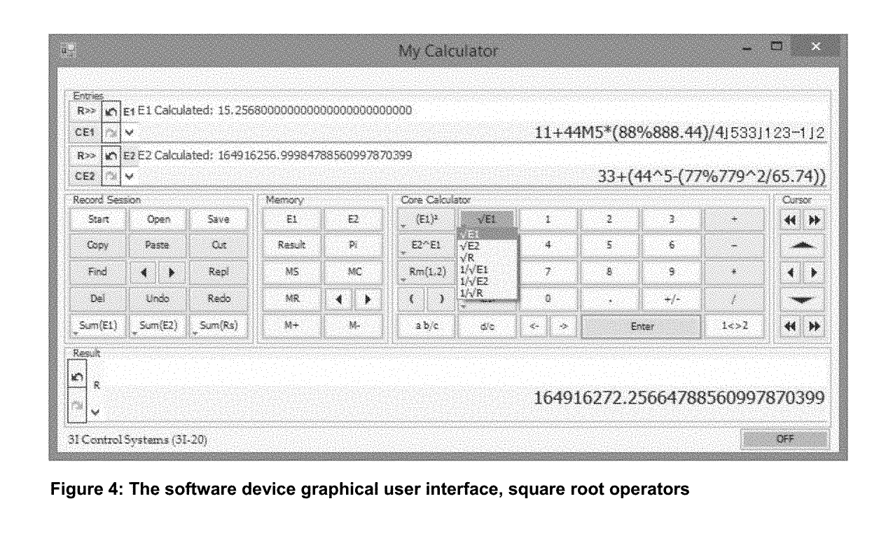

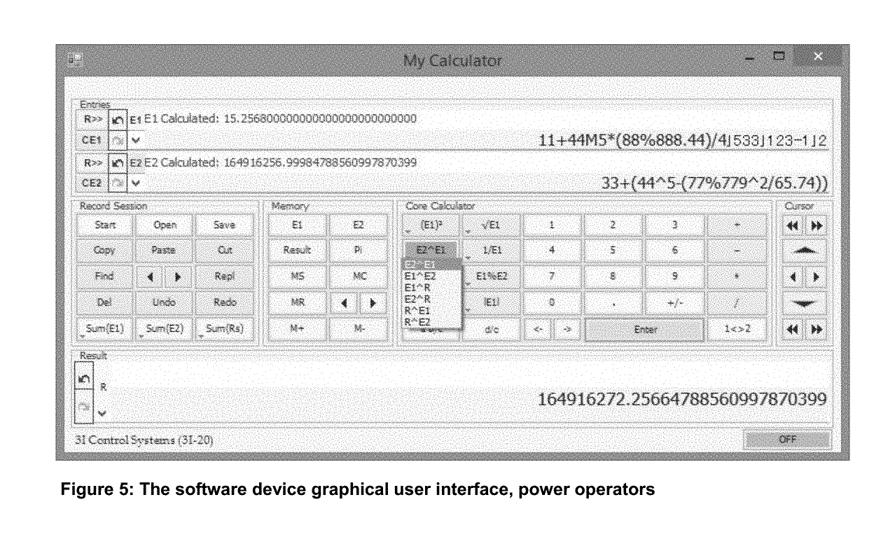

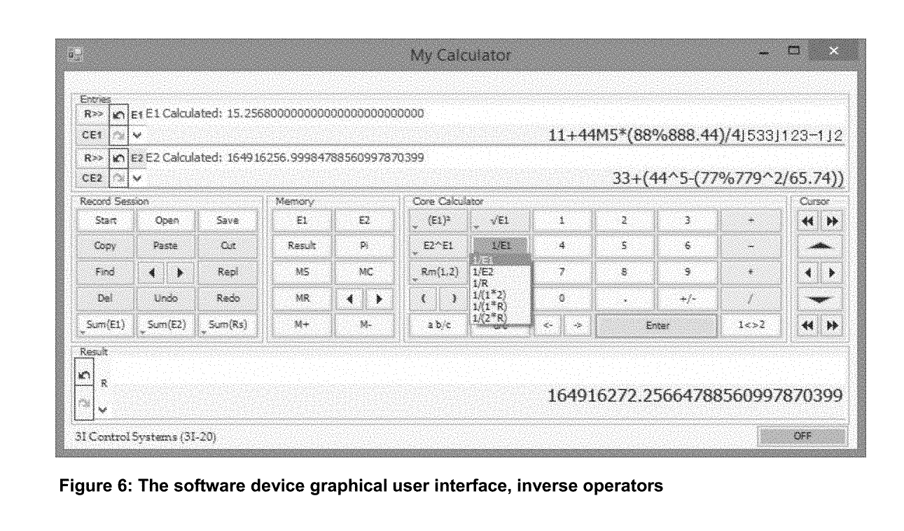

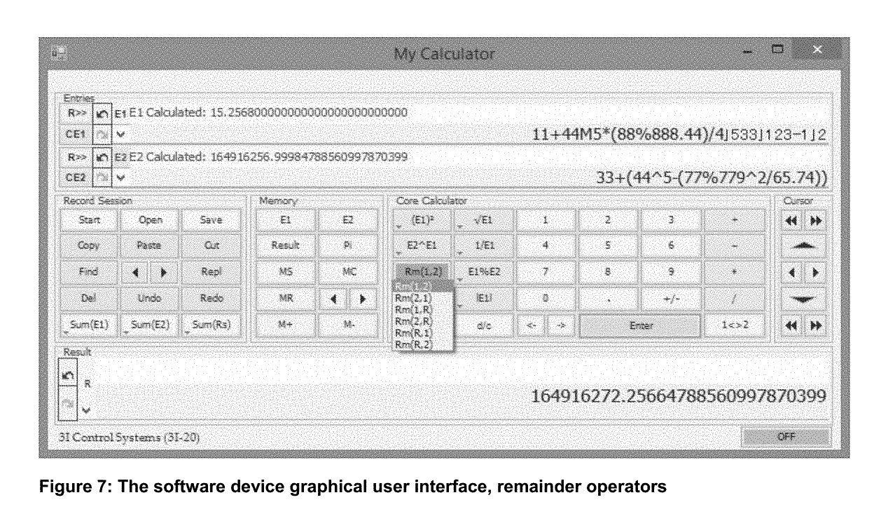

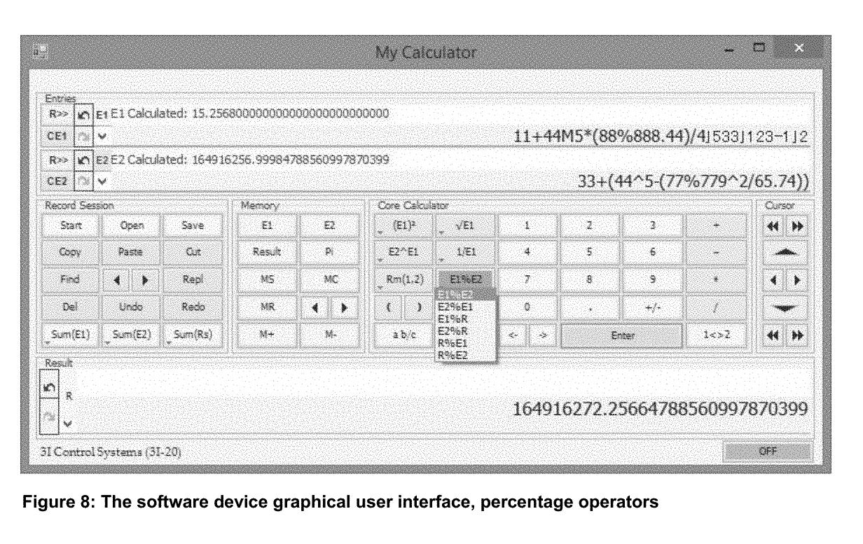

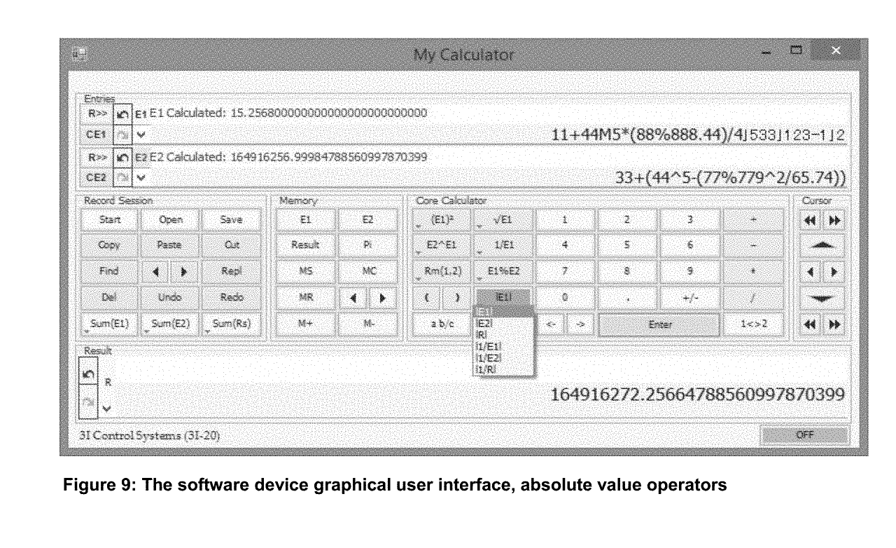

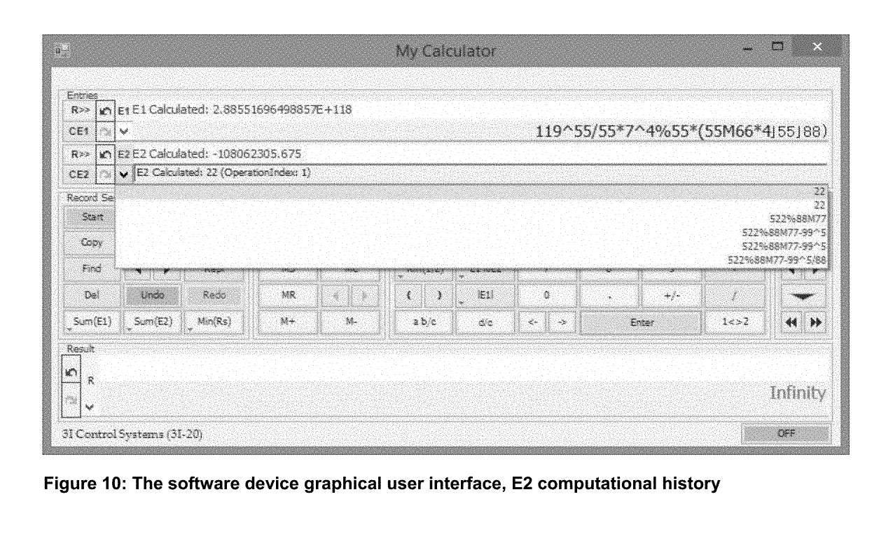

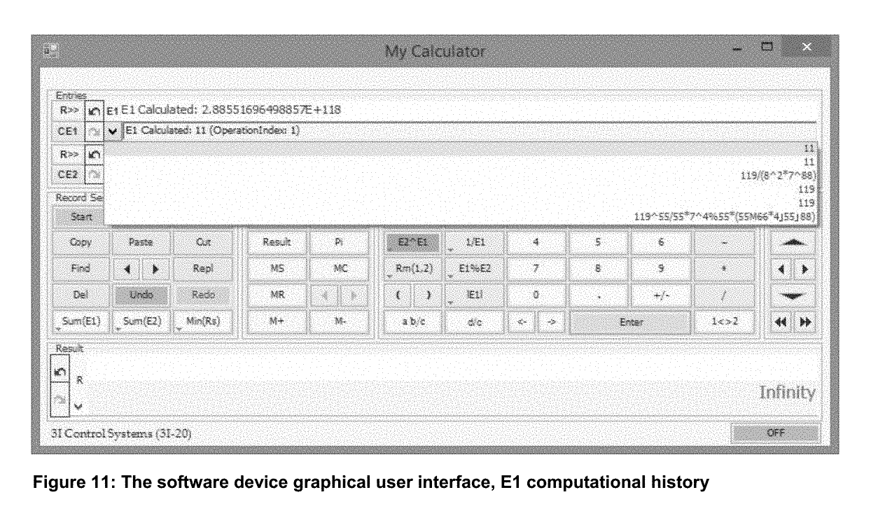

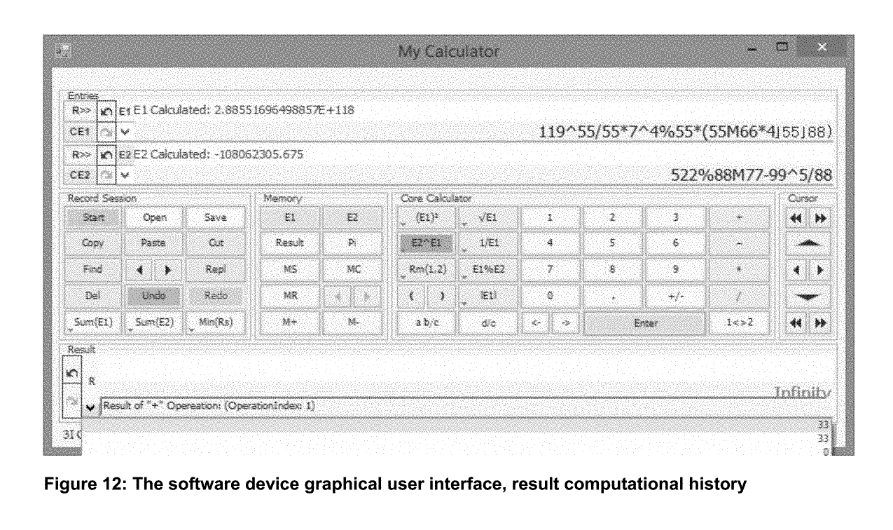

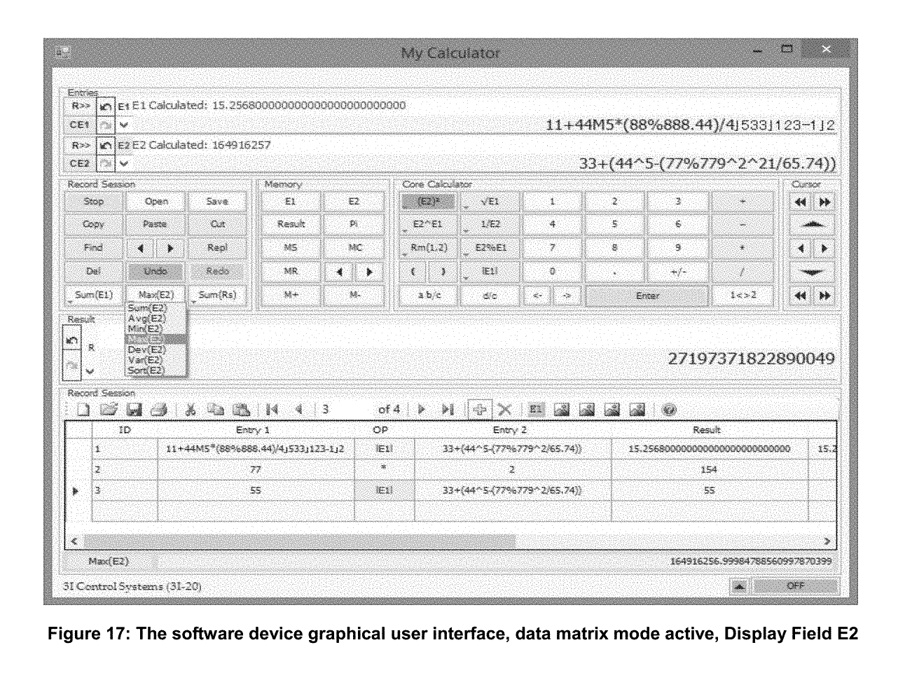

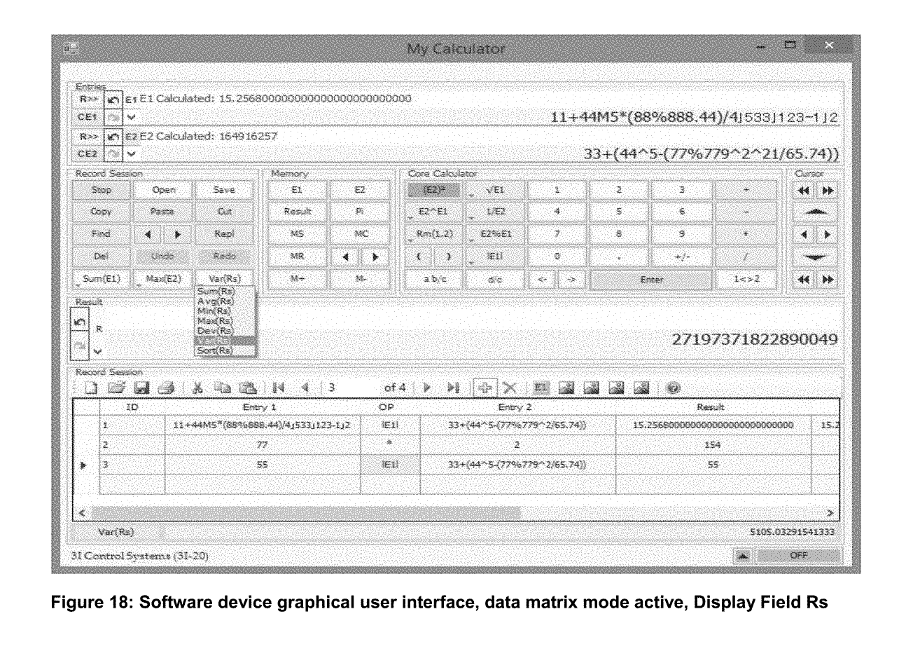

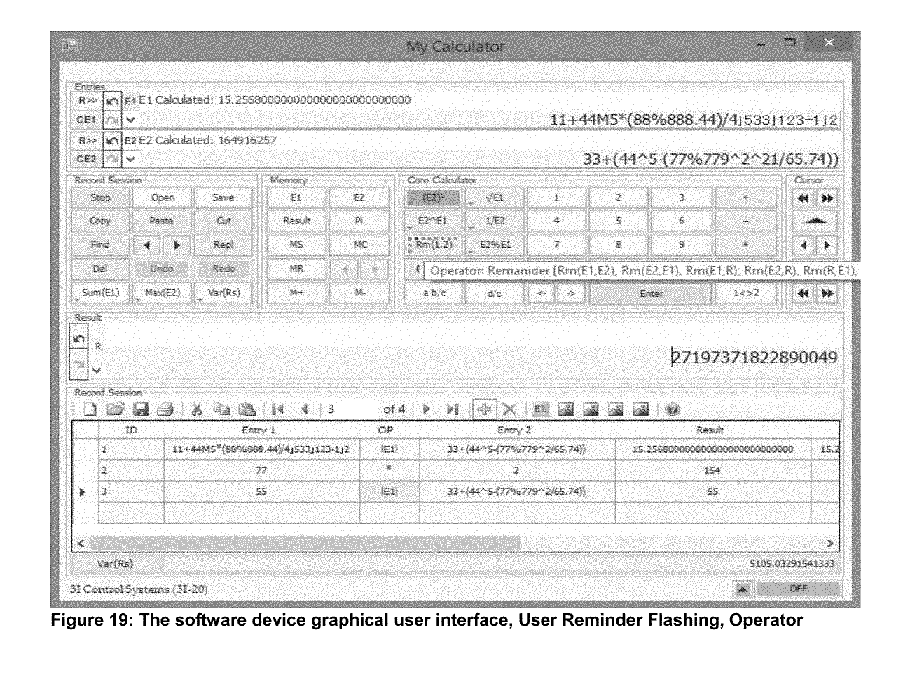

As a result, data matrix embedded capabilities, result piping configurations, user history display and extraction, dynamically selectable operator types, selectable Record Session data matrix column calculations, redo and undo capabilities, and the entry mode selection to enable fractional entries/displays are conceived and realized by relying on this aforementioned approach, FIGS. 1 through 21.

### Software Device Initialization and Startup

The software device startup process is consisted of initialization of operating system framework components to include the control buttons, windows forms, display panels, and entry panels all to be initiated by the platform software libraries, and then initialization of the manually added components to further enhance the performance of the device. These initialization sequences are taken place by the calls to two separate wrapper functions each embedding sequenced individual component initialization routines.

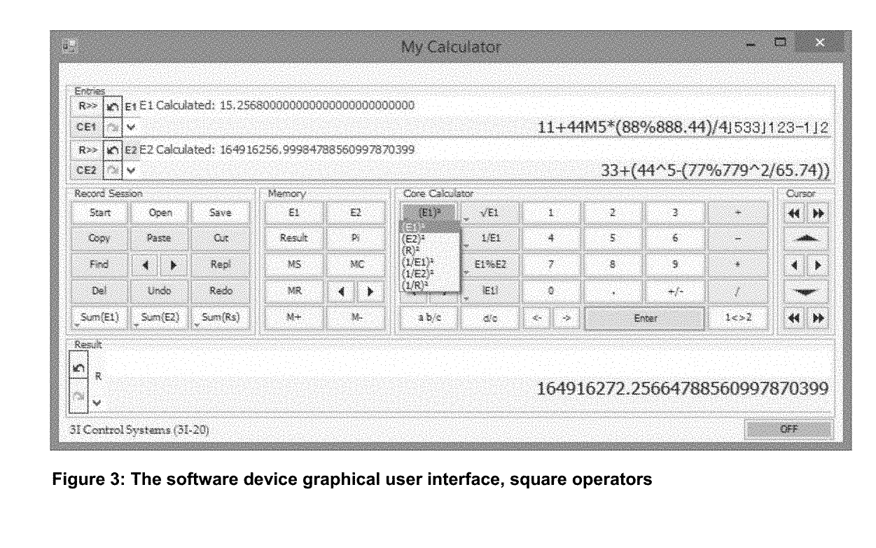

The software device initialization process is then continued where a single top layer method forms and configures the class objects required for the device startup and materialization of the default graphical user interface elements. This includes generating the structure objects associated with the control buttons tag names and instantiation of the dynamic Core Calculator control buttons, which are abstracted and would only be accessible via the drop down menus FIGS. 3 through 9, in addition to the memory control buttons' name tags.

The initialization process is further progressed by setting the initial states for the control buttons while invoking separate methods allocated to memory buttons, cursor movement buttons, record session buttons, and the core calculator buttons. Then followed by the default settings of the entries panels and the result panel, core calculator last record and operation mode structural objects, generation of the objects for math engine and user interaction history classes, initiation of the resource manager for alterable cultures, and initialization of the parser components.

The above are the chain of actions for each of the aforementioned initializations which are performed by dedicated methods calling the required lower level initialization routines to complete the type of initialization and setup regimen.

The software device at this stage continues with the remainder of setup and initialization processes, to configure the custom components and entities. This is to encompass the initialization of the data bases allocated to both the user interface history and dynamic control buttons parameters. To be continued by initialization of the mouse events dedicated to core calculator, memory, and record session panels. At this stage formation of the input output objects, enforcement of limit parameter settings, implementation of timers' settings and instantiations, and finally generation of the event handlers associated with custom events are undertaken.

The aforementioned initialization stages completed successfully, the software device continues this process by further configuring the application localization cultures, and loading the user reminder arrows on the applicable control boxes. Then the tooltip insertions for the graphical user interface entities, and creation of the startup threads are taken place. To be followed by setting the focus trends for the input panels and their associated controls, setting up the applicable controls, fore and background colors, and startup of the undo redo management components.

### Software Device Top Level Architecture

The software device incarnation is divided into the main architecture in charge of providing the concurrent services at any instant of operation and governing the device operation, and the peripheral subsections associated with the graphical user interface. The embodiment of each category are further described as following.

CORE CALCULATOR: This entity is a peripheral layer embedded within the graphical user interface to perform and manage the interactions with the package if initiated by the user interface Core Calculator panel. Namely, to provide numerical and operator entries in an input expression, provide a dynamic facility for the user to depict a desired operator dynamically, switch the entry mode to fractional data types, alter the entry media between the two entry text boxes, manage the entry position, deletion of the single or multi character entered expression segments, and the start of computational tasks between the populated entries, FIGS. 1 through 9.

MEMORY: The panel as a software device peripheral layer provides the user with the methods to request the storage of new data/expressions, overwrite the already stored elements, or retrieve stored entities. The panel provides two controls one for adding and the second for subtracting a selected entry or result from an already stored data/expression.

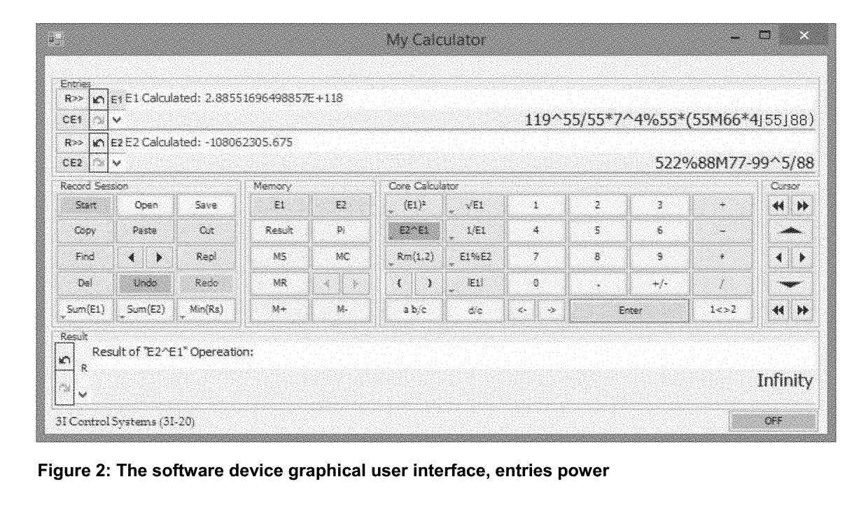

The memory panel contains control operators for selecting the memory entities as a single or combination of the entries and result, and the operators which open a temporary popup window to display a modifiable index number for the intended operation. Selecting the desired index leads to storage or retrieval of the data/expression associated with the types of memory operation, where two additional index navigational control buttons are also accessible within the Memory panel, FIGS. 1 and 2.

RECORD SESSION: Record session as a software device peripheral panel provides access and control during an active record session and governs its associated data matrix. The start control button starts or hides the data matrix display, the open and save control button populates the data grid with a stored specially formatted previous saved session flat file, or saves the data matrix contents as a flat file on the host platform.

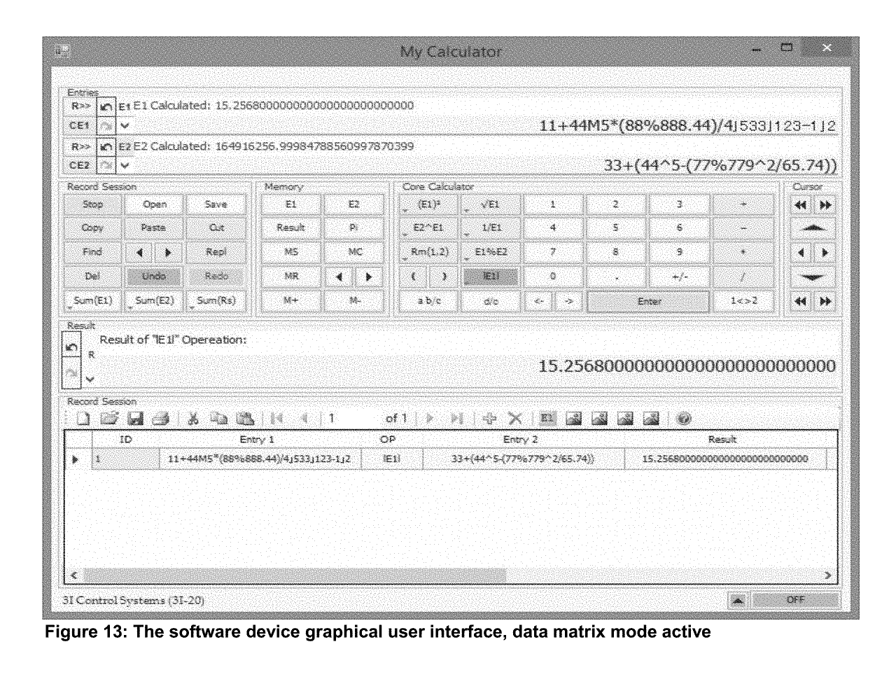

The copy, cut, and paste buttons perform any of the noted operations in connection with the data matrix selected cells, copied cell contents, or from external tools as spreadsheets and text editors. During the course of copy or cut the selected cells within the data matrix start and continue flashing by altering their cell background colors distinctly for either operation, as a user reminder for the allowed time duration to complete or reiterate the process, FIGS. 13 through 15.

The record session panel also provides search and find capabilities to allow such operations to take place within the data matrix cells' contents, with navigational back and forth buttons to reiterate the process throughout the entire data matrix cells.

Delete button removes the selected cell contents, the Redo and Undo buttons provide the capability to navigate throughout the alterations or additions made to the data matrix, and permits the selection of any of the changed state contents, FIGS. 13 through 15.

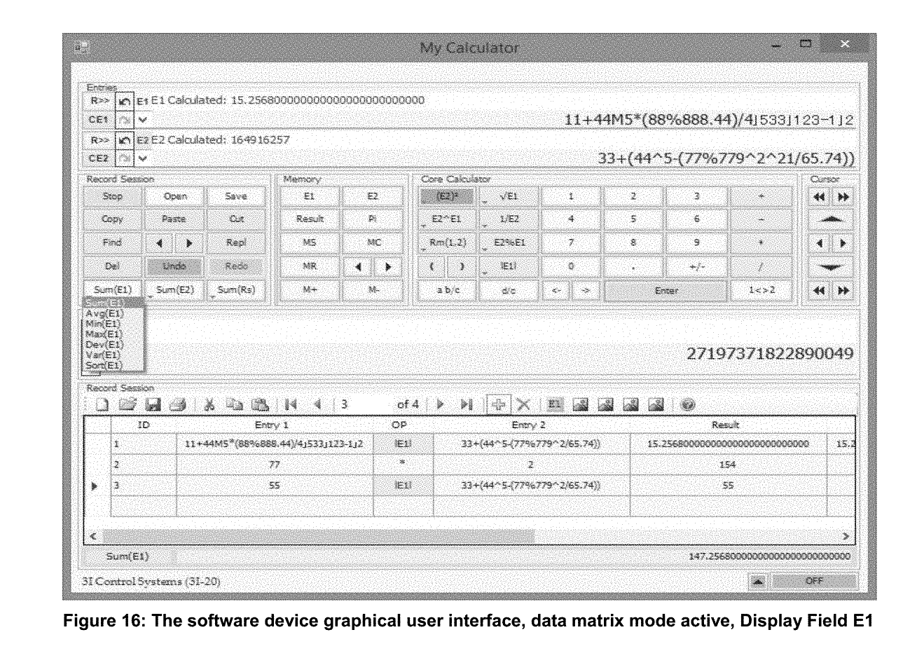

The last set of the record session panel buttons are allocated to entries or result columns mathematical or statistical calculations. For each control button a number of operators are available, which are dynamically selectable by the dropdown panel activated by pressing the right mouse key and when positioned on the selected control. Selection of any of those operations with the exception of sorting, result is appearance of a display banner at the lower edge of the matrix to contain the description and the result of the calculation. The calculation could be set by the use of the applicable context menu to remain unchanged after a column calculation is complete, or be updated on real time when the data matrix content is altered, FIGS. 16 through 18.

RECORD SESSION DATA MATRIX: The data matrix is the record session pivotal user interface panel, capable of having a complete computational operation as a single row with the entries made of either a mathematical expression or numerical data. The record session panel described above contains the control and navigational buttons to populate the matrix or alter its content. An iconic banner at the upper edge of the matrix either duplicates the panel operators or enhances the matrix control apparatus.

The data matrix is deployed to provide further capabilities including editing of existing cell contents, adding new populated or empty rows at any arbitrary position within the matrix, and moving any set of cells within the matrix to populate empty cells or to modify already populated cell contents, FIGS. 13 through 15.

The data matrix is also designed to capture any new core calculator computation as a new row to spontaneously populate the remainder of the row cells including the mathematical expression data values, the operation result value, and the applicable index for the appended row.

Performing such calculations are a very dynamic real time process, which takes place at the instance the proper entries in combination to an allowed operator are entered within a data matrix row, or intuitively every single line acts as an independent computational entity to perform the calculations and update the remainder of row cells where the entered data are done manually by editing the entry cell, or automatically when a core calculator computation is taken place, FIGS. 13 through 15.

The data matrix entry error handling and notification subsystems which is only required when direct entries to data grid is made via cell editing. Where, encountering an errors results in removal of the existing result columns and the applicable calculated entry columns. This is combined by an error indicator scheme to have the error contained cells fore and background colors immediately altered, and only changed to the original colors for each affected cell as prompt as the cell content is corrected and the cell edit session is completed, FIGS. 13 through 15

SESSION STORAGE FILE: The software device uses a file media for data matrix content storage and retrieval. This is performed via the host platform operating system when the involved parameters as the file name and directory path is acquired by the graphical user interface for both persistent session storage and or retrieval at a later instance.

The file store and open dialogs to complete such a process is provided by the operating system, and the user is either confirmed of a successful generation of the stored file, or the refreshing of data matrix cell contents in accordance with the retrieved file, FIGS. 13 through 15.

ENTRIES: The software device dual entry panels are the media for entering numerical data, operators, and overall arithmetic expressions, where the calculated result of each entry expression is exhibited at the upper left corner of the display during and at the completion of the insertion process.

The two entry panels are designated to inherit similar behaviors and structures to enhance the user interactions with the graphical user interface. Erroneous expression entries result in the panel's textbox fore and background colors to change combined with clearing of the top left corner expression result at the instance of entry. The affected display returns to its normal operating state when the last erroneous character is removed, all performed on real time bases, FIGS. 1 and 2.

The left side of each entry panel is allocated to a result piping enable/disable button to refresh the entry text box with the immediate result at the conclusion of each computation. This is to provide the device feature to only update the second entry for a trail calculation.

Also for each entry panel there is an associated clear all content control button, and two additional undo redo buttons to navigate and select any of the previously entered entities. In addition a history button on each panel opens up a dropdown window to exhibit the prior entries as single row elements, each selectable by the click of the mouse while the history dropdown display is visible, FIGS. 1 and 2

RESULT: The software device result panel is implemented to have similar shape to the entry panels described by previous subsections, where the computational results are presented at the lower segment of the text display box, and the operation summary at the upper left corner.

Encountering a computational error the fore and the background colors of the panel text box are altered in combination with the operation summary removal. This is to inform the user of the error occurrence. The result panel would only be restored to its original state when the error is corrected.

The left edge of the panel is allocated to two undo redo control buttons, providing the capability to navigate throughout the prior results, when each navigation cycle refreshes the result text box in combination with restoration of its associated entry values placed accordingly in each entry box.

The history arrow provides the same capability as the redo undo buttons in a more visualize manner, when each prior attained computational result is displayed as a row and depiction of the row accordingly refreshes the entries and result box contents FIGS. 1 and 2.

### Software Device Top User Controlled Components

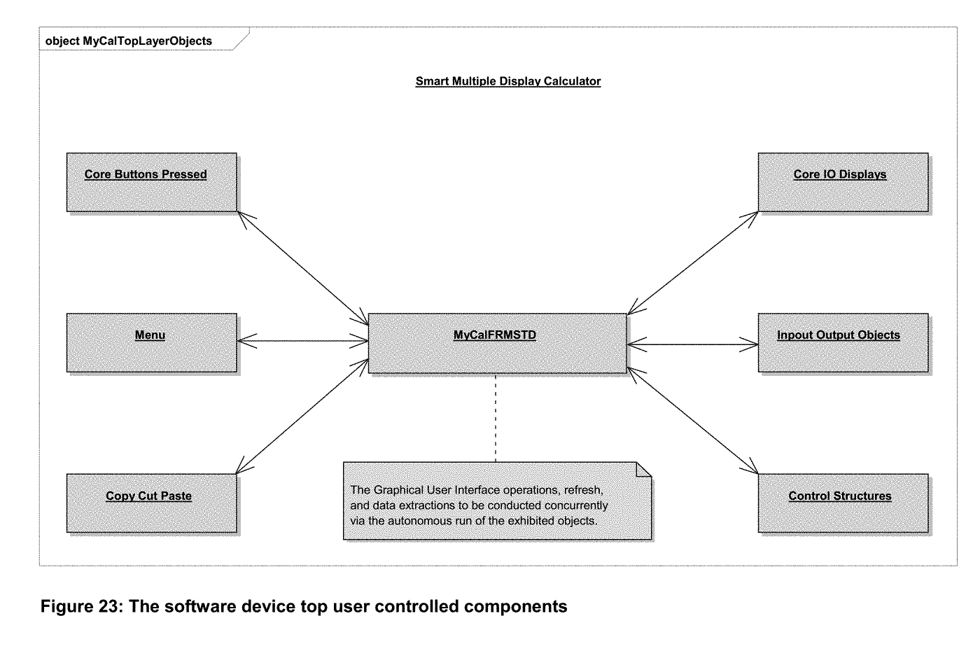

At this part of the software device embodiment section, descriptions are pinpointing the varied roles performed by the layer of software components which are in direct interactions with the graphical user interface on one end and more internal software layers on the other. These components are entailed to objects capable of providing autonomous services to the graphical user interface, manipulate and reshape the user interface, or to purely assume a transitory role, FIG. 23.

CORE BUTTONS PRESSED: The software device core calculator panel control buttons' generated events are directly captured and controlled by the software components namely the code services. These are events instantiated by numerical entry buttons, by operator insert control buttons, to include the insertion of parentheses, backspace, sign change, entry exchange, delete processes, fraction mode insertion and selection, and the multifaceted operators with the drop down selection processes.

The above mentioned processes and their applicable outcome are isolated in their internal functioning due to the need to have them executed mutually and concurrently which provides the required synchronization and the data entry sensing demanded for the applicable performance. As a result each is ran as an object derived from lower level code elements to provide a virtual zone between different functional layers strictly based on abstraction and loose coupling between such elements.

MENU: The software device reliance on the graphical user interface and its customization to adapt to the user needs and preferences is further enhanced by deployment of adaptable context menus to provide all the applicable functionalities for a panel. The context menus are either exhibited by default, shown via the dynamically alterable control buttons and the data matrix, or are displayed by the use of mouse keys.

As a result, and depending on the position of the mouse icon an applicable context menu is always available to the end user, to provide the hidden functionalities and settings to match a particular need. In addition the data matrix is controlled both by the Record Session panel, context menu, and a menu bar at the top of the matrix containing its applicable features and controls.

The Menu code elements is consisted of the objects and methods to govern opening of the context menus and clicking context menus entities, managing the operational mode changes, and managing the data matrix menu bar driven events. The code elements are executed when the context menu entities are cleared or selected, or when the data matrix menu bar icons are clicked on. The clicks or menu action items are recorded by changing the applicable object elements states, change the device operational mode, or directly invoke designated methods to perform services.

CORE INPUT OUTPUT DISPLAYS: The software device dual entry panel components are constructed to acknowledge and provide services to events and service requests initiated by graphical user interface elements and the internal requests issued by the device code objects or layers, as prompt as such a request or event is materialized. The concurrent operation of the panels requires synchronization and piping of these interactions to substantiate the applicable execution or fulfillment when utilizing concurrency methods and sequencing.

Clicking within entry text boxes results in start of an edit session and abandonment of the session if it is currently in progress in the second entry box, combined with configuration of the newly started edit session. This includes setting of the selected entry box fore and background colors and granting the box the focus state.

The entry box remained in focus state leads to continuous monitoring by the core I/O components for text alterations, to format the addendum text, generate a refreshed parse tree, evaluate the parsed results, initiate applicable exception handling if required, get the entry runtime mode from the thread, refresh the entry result text, invoke the undo/redo components methods, and check for the timeout violation via the timer threads.

The host platform keyboard strokes during the entries focus states are similarly governed and as a result similar techniques are deployed. This is to include detection and validation of the entered characters, undo/redo stack updates, reformatting of the amended entry contents, rerun of the parsing process for validity of the contents and exception/error handling if required, checking for the proper runtime mode, calculating the entered arithmetic expressions, and exhibiting the result string.

Checking for mouse button double-clicks results in granting focus to the applicable entry text box, examining for the entry box state to verify it is in arithmetic expression or numerical operation mode, manage the switching of the insertion point between the two entry text boxes, the edit statuses, functional states, and the need to refresh the entry results displays. These actions are intertwined with the entry boxes error handling scheme to namely show warning notices, altering the affected box fore and background colors, or disabling/enabling of a set of applicable correcting or editing features.

Each entry panel includes result piping control buttons to activate the piping if enabled. This is to have the valid results immediately sent to the depicted entry text box, with the update of the calculated entry values to be refreshed and displayed by the entry box. The entry panels clear control buttons are one time only acting controls to clear the affected entry box content immediately as such an action is provoked.

INPUT OUTPUT OBJECTS: The software device graphical user interface architecture provides further encapsulation when interfacing with the code data objects and control layers. This is done by utilizing input output patterns to contain the interface mechanism at the very top layers, and connected to the lower level code layers via utilization of the custom input/output objects.

These objects get dynamically created and configured, and would remain present until their roles are no further required. They provide distinct IDs and state information during runtime, provide accessory roles to get or set string queues, retrieve or set parsing trees elements, and provide runtime access to the pertinent data associated with the input output entries or exchanges.

Managing the transitional states pointing to the focused input output media and the roles of switching to the dynamically altering intended media, providing media refresh services, coordinating with undo/redo and history extraction processes, and the funneling of the outputs to the selected inputs are all performed by instantiation and use of the input output objects.

Input Output objects also provide services to the memory, history, and undo/redo components when streaming newly modified input output contents, including data retrieval requests, retrieving data from memory, depicting history items, or when undo/redo information is required. Collaboration between these components and the input output objects is performed by deployment of identical internal state objects to reflect the characteristics of the interactions and infer the intended input or output media. At any instance these are the key parameters to define the focal media, and make the transition between them possible.

CONTROL STRUCTURES AND CLASSES: The software device is architected to contain loose objects with defined interfaces to make their interactions possible. This pattern and approach as a design principle has produced varied objects even within single components, when the internal and external processes' interactions within or with a component instantiate tracking and updates to the control objects.

The device architecture has considered four top layer control objects which by relying on inheritance and aggregation techniques they embody their lower level objects, each object entailed to its scope of operation and visibility. These top layers are consisted of core calculator objects, input output manipulator/interaction objects, memory manipulator/interaction objects, and graphical user interface manipulator/interaction objects.

Core calculator control objects refreshed and updated by the varied layers of calculator code encompass, core calculator operator types made of the arithmetic, power, remainder, percentage, square, square root, inverse, and absolute value operators.

These operators perform calculations on combination of entries and output entities which are all accessible and visible via the graphical user interface. These control objects require additional entities to tag the selected operators and track theft combinations during arithmetic processes. This has resulted in creation of core operator tag objects, cursor move tag objects, core operator button symbol objects, and core operator text symbol objects.

The core calculator control objects in consideration of providing spontaneous services to other components merely based on the last performed operation, keep a cache object as a full record of the last undertaken operation. This object keeps a copy of the entries and result text box contents, in parallel to retaining the content of the descriptive results and texts displayed by the entries and their result text boxes, while the entries are getting populated or a computational result is attained.

The operator buttons depicted operation types which are persistent upon the selection by the user are all attained by the core calculator objects. This is to identify the active operator specified by the control button and the depicted operator symbol tag. The initial content of all these objects are the pivotal information utilized by the device to instantiate the upper code level objects.

The device selected mode of operation is also tracked by the core calculator control objects, to include fraction, numerical, or arithmetic expression entry modes. Control objects are further deployed to keep track of the generated exceptions and the activation or deactivation of control buttons and entry/display sets, in combination with the states to initiate the characteristics of the graphical user interface. Tracking of mouse clicks or double clicks and the drag and drop states are also recorded by the core calculator control objects in regard to the last performed operation.

The software device interactions with the memory components is governed and monitored via the use of memory control objects to contain the memory operation types and their associated tags. These objects get generated to keep track of combined active memory panel buttons, to interact with the memory component threads, and the most recent memory process.

The user graphical interface operations facilitate interactions conducted between the software device and the user interface, namely by examining the control buttons activation states, the display contents, occurred errors and exceptions. This leads to customized object states to identify the applicable presumed inner components statuses or the forthcoming inquiries or processes to be undertaken.

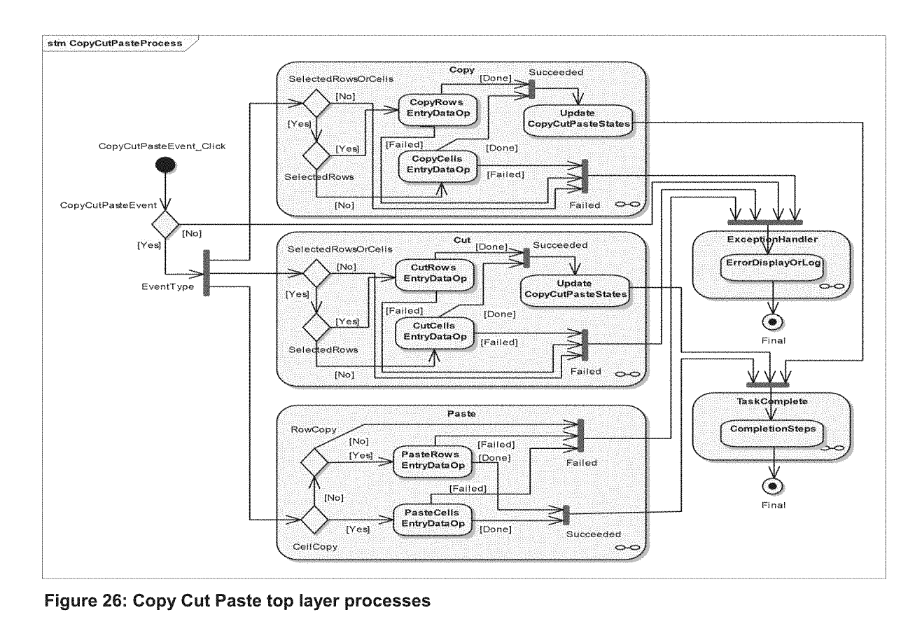

COPY CUT PASTE: The software device copy cut paste objects are consisted of a multi layered architect, to conduct these operations both within the entries and output in combination with the data matrix while the record session is active. The copy and paste originated from the entries or result text boxes are carried out by invoking the context menu and selecting the proper action, when in active record sessions the entire computation tasks to include the entries, operator, and the result get inserted as new added row to the data matrix, FIG. 26.

Data matrix Copy, cut, and paste processes are conducted in two separate categories, one for full row copies and the second partial row selections. This is done to speed up the initial paste content analysis to infer the positioning, validity, or the need to format the copy content, prior to the start of the paste process.

The cut process is performed with almost full resemblance to copy process using identical code objects, with the exception of the initial object layers to configure either process accordingly, and then after completion of the paste to clear the copied elements in the case of a cut process. As a result throughout this subsection, the terms “copy” or “cut” are referred to by the term “copy”, unless a distinction needs to be made.

The graphical user interface initiates the copy, cut, or paste processes strictly through a single object method, when by controllers objects contents and the generated events the process is applicably funneled to the lower levels of the code. The copy process is conducted by first verification the validity of the content streams, then followed by reformatting and queuing the content to be utilized by a forthcoming paste task.

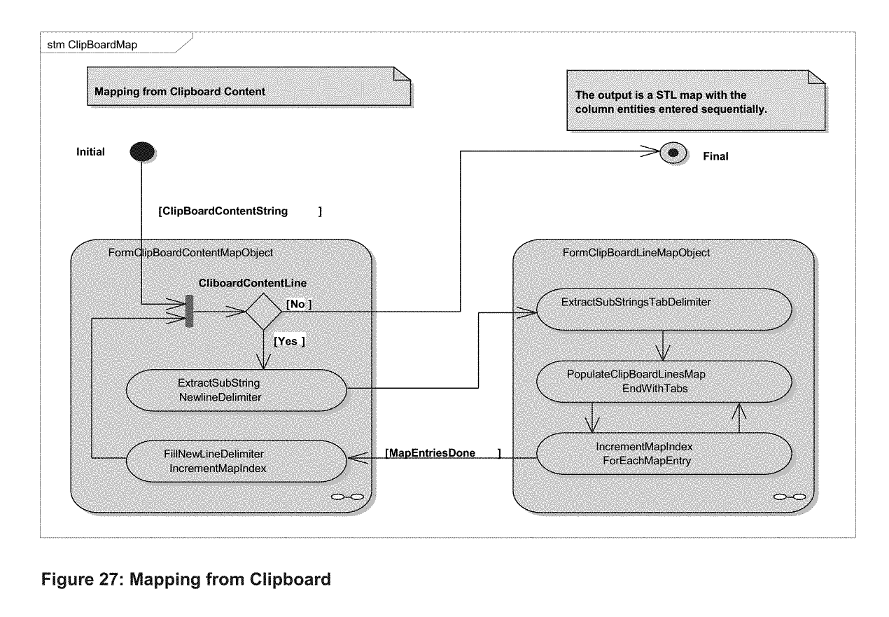

The formatting is taken shape by detection and searching for the cell content designators. Namely to include the end of row line or cell assigned characters, and asymmetric properties of the row lines and row cells, FIG. 27.

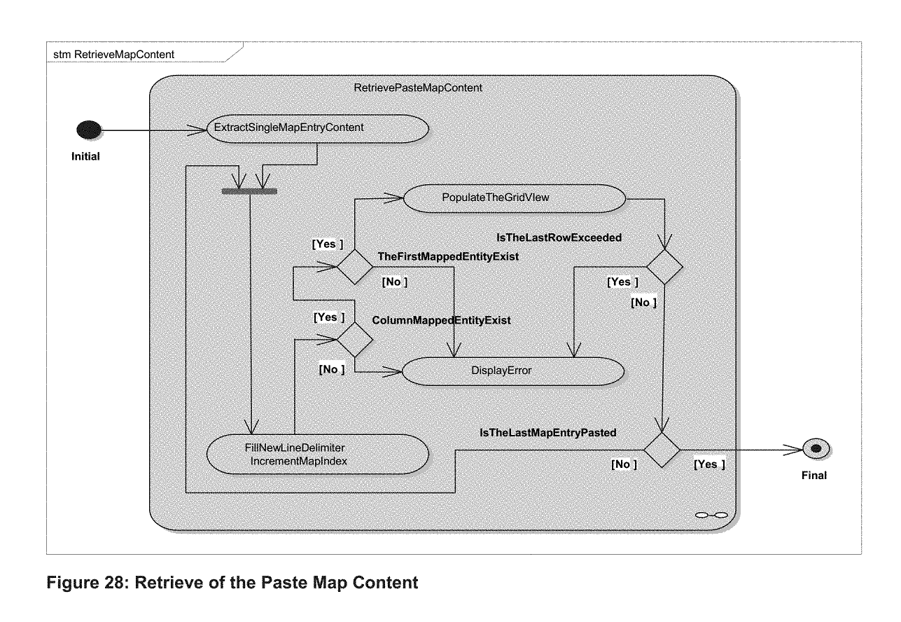

The paste process is performed first by detecting the copy source to be internal to the data matrix, or originated from an external tool. Detection of an external copy source invokes the tasks and the thread to reformat the copied content and signal the paste process to continue, only if the formatting has taken place properly and the copy source is applicable to the format, FIG. 28.

The external paste also requires the user to specify the starting column type before performing the paste. The acceptable column types are inquired via a popup user interface, and the user response gets stored to be utilized by the paste process. As a result and by the copy reformatting service, every cell and row in addition to the end of records get tagged via specifically defined symbols and delimiters. This enables the paste process to place the content within the applicable cells and matrix rows.

Prediction of the matrix starting cell and row at the beginning of a paste process demands the software to infer the positions based on both the cursor position within the data matrix, in addition to the constraints to detect and verify the types of cells which are editable. These are the sub processes invoked to extract such information and to populate the applicable control objects accordingly.

The paste process also inserts additional empty rows if dictated by both size of the data matrix and copy content, these are the host rows to contain copied cell contents. The data matrix cursor being positioned within editable cells prior to paste is directly utilized to pinpoint the paste starting cell, the software then and if required trims the additional copied cell contents within the formatted stream to accommodate a detected inconsistency, the same when the cursor is placed within a non-editable cell prior to paste which again deploys the inferring code to conclude the nearest applicable paste start cell.

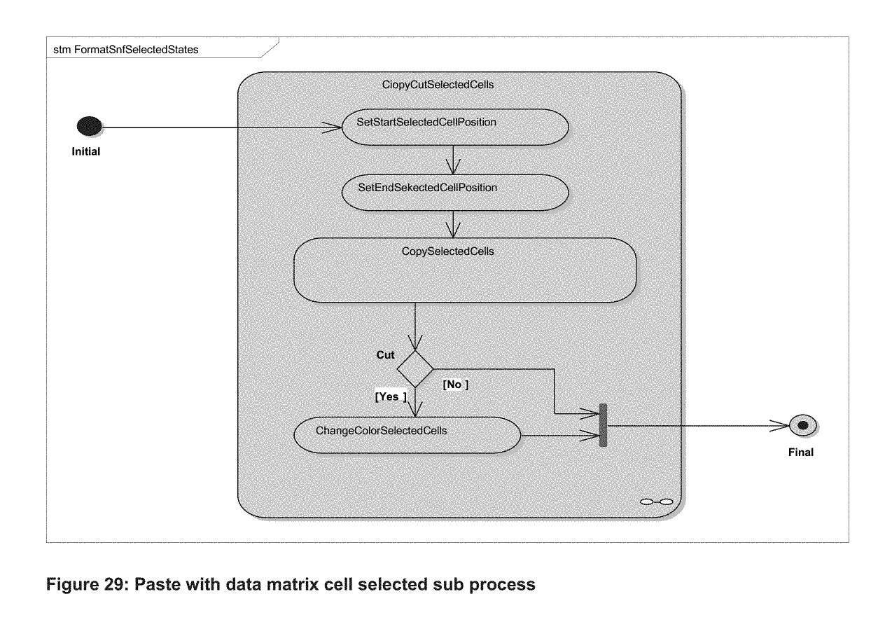

The paste process initiated while a portion of data matrix is selected requires further decision making by the software. This is to compare the selected pattern with the copy content to replace the selected cells fully or partially, and accordingly depict the paste starting cell. The paste into selected data matrix cells are further illustrated by FIG. 29.

The data matrix is capable of providing computations for each row as they get populated either by the core calculator, or manually by editing individual cells. These functionalities are further extended to copy, cut, and paste process as well. As a result the software is capable to synchronize the computations initiated by the newly pasted rows and cells in real time, and to keep the operations concurrency while the paste process is in progress.

Exception and error handling during a paste session is carried out in full compliance with the alteration of the individual cell content, when the cell with erroneous insertion spontaneously alters its fore and background colors and the result and applicable “Calculator Entry” columns contents are removed. The computations and exhibition of the result are only resumed when the column with the erroneous entry is corrected.

### the Software Device Service Components

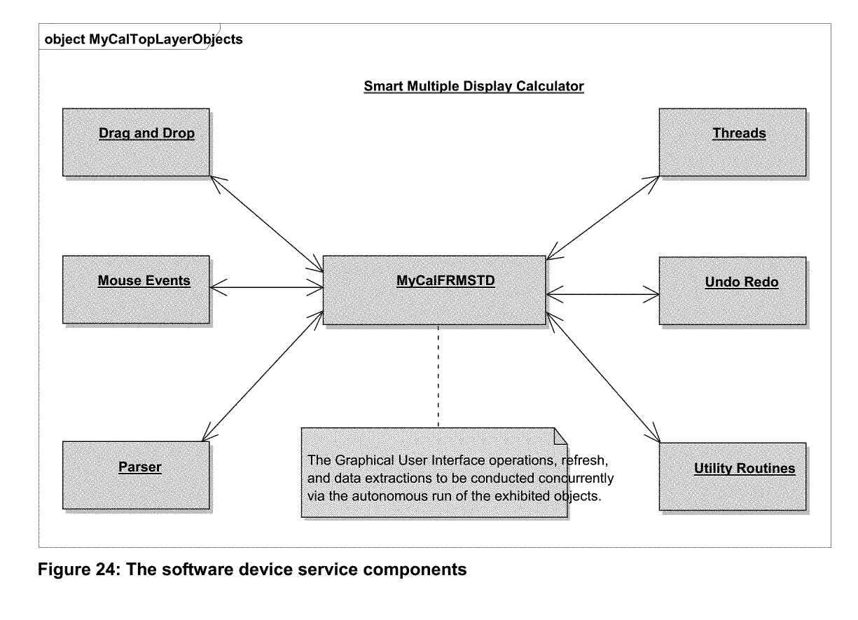

The software device has initiated a computational task, invoked by graphical user interface, or requires parsing processes, all to be fulfilled by the software service components to provide the requested services or to respond to them. FIG. 24 exhibit such components and services which are further described throughout this section.

The important aspect of synchronizing and sequencing such services after demand lays in conjunction with using threads and graphical user interface generated events, combined with deployment of queues, memory sharing techniques, and signals.

DRAG AND DROP: The drag and drop software is implemented to depict highlighted text segments and to move them between the entries/result text boxes, or data matrix cells. The drag and drop process starts and is conducted by the generated user interface drag and drop events, each managed by the drag and drop sub processes to identify and validate implementation of the services, or the applicability to move the content from one controller to another, when such an action is not prohibited.

MOUSE EVENTS: The software device relies heavily on the events generated by the graphical user interface elements, their types, and their occurrence sequence to provide the signals required to govern the multiple text boxes and the data matrix entities. This is to analyze the user demands and infer the control object content and behaviors when varied functioning states are entangled with the instantaneous applicable constraints.

The device code partitions the mouse events based on core calculator, history, memory, record session, and undo/redo event groups. The separation is conceptualized by the need to deal with their applicable code components and elements in both conjunction with the device software architecture, as well as an approach to comply with the code encapsulation and abstraction principles.

Core calculator mouse events are heavily focused on controllers click and double click type events, which signal the lower code layer services for setting of the current math operator or operating mode, insertion of the operator within an arithmetic expression, automatic jump of text insertion point, altering the entry text boxes focus state, and making the modification to the entered expressions.

Mouse enter and mouse hover events within the core calculator panel are utilized to provide control buttons appearance alterations and initiate the processes to generate flashing arrows reminding the user of the existence of alternative group operators to get displayed and selected via the user interface, if desired. The hovering, enter, and leave mouse events are heavily used to signal start and cease of user interface operations, or altering the started services and threads.

Entries and result text boxes history mouse events signal its associated drop boxes to show their prior text box contents, which if desired the depicted content is accordingly restorable within its associated text box. These events generate signals issued to the lower history code layers to display the history contents, and accordingly to replace the depicted text box content with the selected history item. The same mechanism is deployed by the code to close the dropdown box, by the second mouse click on the history arrow control button.

The memory panel is entailed to its own mouse events to set memory active modes by inclusion of the entries and result text box contents. Mouse click and double click on the memory panel control buttons are handled by this layer of code, which includes store or retrieve functionalities, signals to start or stop activity timeout duration, or call of memory manipulation functions.

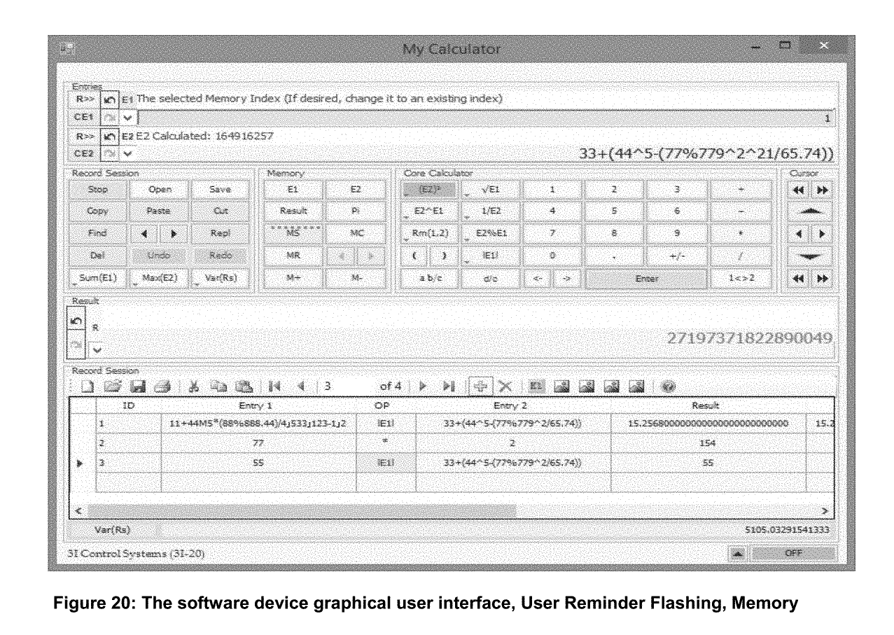

The memory storage takes place by indexing the stored values in an array container. Control buttons MS, MR, MC, M+, M− signal a timeout tracking thread to abandon the request if the following steps of the memory operation are not undertaken by the user. The timeout remains active within the given time duration, then and if the timeout is elapsed the memory process would be ceased automatically, FIG. 20. This is also concurrent with the opening of a text box at the lower part of the entry 1 panel to show the memorized entities, when it becomes inhibited by timeout duration elapse if the undertaken memory process is not completed by the user.

The memory text box gets populated by the next consequent index number which is editable to any desired value, useful in the case a memory value needs to be overwritten, retrieved, incremented, decremented, or cleared.

The software would also reallocate both entries and result history dropdown controls to exhibit the memory arrays for each text box, with the highest indexed memory value displayed at the top and the rest to follow. Clicking on any of the values within the dropdown boxes performs the operation on that set of value when the displayed memory index value gets altered. This is to provide the user the opportunity to continue with the remaining memory operations.

The record session events are deployed to track the mouse movement within the data matrix panel, which includes click, double click, key down, key up, cell and row selections, got focus, cell painting, cell editing, and icon bar events. Selective cell entry events to include value change, cell content click, cell focus lost, key down, key up, and key press are enabled and disabled within a computation process to give the required priority to the services that record any performed computation within the data matrix.

PARSER: The software device entered arithmetic expressions are continuously parsed during the entry times. This happens on the fly for validating their correctness, and whenever a computational process is undertaken. The parser is implemented using EBNF grammar (Extended Backus Neur Form), as a fully wrapped component set with a single interface to be utilized by the software device. The success or failure of the parser components to parse a received entity will be passed as part of the service back to the client code, to proceed with the calculation or take any required exception handling measure.

UNDO REDO: The undo redo code components are implemented by the use of separate revolving arrays to record any performed calculations. The software is architected to increment through such queued elements via the mouse click events generated by either of the undo or redo control buttons associated with each entries and result control panels, FIGS. 1 and 2.

Software keeps track of the pointer pointing to a depicted queue position, makes required alterations to the pointer if a redo/undo process is overwritten, and enables or disables the undo or redo control boxes by relying on the pointer position within the queue.

UTILITY ROUTINES: The utility routines are made of transitory object methods to facilitate and validate transactions between the code components and objects during runtime. Marshalling object conversions when they are passed through, and reformatting of the object instances, are all taken place by the invocation of these routines.

The software architecture is designed to provide exception detection and handling when such routines are called, which stops erroneous data object exchanges and provokes the steps to inform the user and if possible to correct the incurred error through the use of the applicable error handling schemes.

THREADS: The software device heavy reliance on the thread services are instigated by the need to concurrent validation of the entries, computational processes, error and exception checking and handling, and alterations to the user interface appearance base on the exerted constraints and device dynamic behavior.

As a result, coordination and synchronization of the results between the data matrix and the computations initiated by the core calculator demands a substantial degree of multithreading, furnished by timer threads, event driven threads, and worker threads.

### The Software Device Core Service Components

The software device core services are provided by software components to include session storage file handlers, history, record session, data base, calculation engine, and fault and exception handler. These entities are implemented with loose coupling when interacting with the higher layers of the code. As a design approach interactions between these components is not mutually permissible, such interactions are managed by the client code and by requesting their needed exchange services. This is the principle observed by the fault handler as well, where the exceptions and errors are first conveyed back to the service requester.

STORAGE FILE HANDLER: At the start up, the software device initializes the file handler objects and dialogs to be shown when such a service is requested. Then the software configures and correlates any file dialog and service as an entity only associated with the data matrix and only allowed to be requested when a record session is active.

The two main services provided by the file handler are consisted of an object process wrapper to open an existing storage file, by exhibiting a file open dialog popup window to search and select the intended file. The second object process wrapper stores the data matrix directly to a storage file by the use of popup windows for selection of the directory path and the file name, via the confirmation of the user to save.

The file store process is equally applicable when overwriting an existing storage file. In addition a popup window confirms the user intended overwriting by inquiring the user, prior to the storage.

Additional sub-processes and control objects methods are called by the above processes to manage formatting data matrix contents into the file streams and vice versa, and managing storage file content merge into the data matrix.

HISTORY: All The interactions taken place within the entries and the display text boxes are stored by the history components while the core calculation processes are undertaken. This is to provide the user the ability to switch to a prior calculation via the use of the history control buttons and their associated dropdown lists, each allocated to an individual test box. The control button to open the history elements or the text box history dropdown display is an arrow control button sat at the very low left bottom of each text box, FIGS. 1 and 2.

The history process is implemented via an ODBC database, linked to the controller actions via a designated dataset. The transactions are stored on a cache media by the data set, and stored when required to the data base. The intent is to store an entire session by preserving the data base contents and the data matrix via a persistent media to close a calculation session at any desired stage and reopen it at a later time.

RECORD SESSION: It was at a later time and when the core calculator initial concepts, design, and implementation was at their late evolving stages that the need for having a visual media to more graphically exhibit the calculations was emerged. This is achieved by the use of a data matrix window where each row of the matrix represents a single computation, made of pure numerical or arithmetic expressions as entries with the operator cell, and have the calculations performed in real time as soon as the inputs are entered, leading to immediate display of the final result by the row Result cell.

The data matrix is realized by the use of a data grid element capable of expanding dynamically as more calculations are inserted into the grid, have the required event generating capabilities tied with independent editable cells, and the ability to be linked to a data base via an allocated dataset. All to materialize the constant two way coupling required to interact with the core calculator, the data base, and the record session control panel. Still for each grid line to remain capable of functioning as an independent computation media.

The record session software also accommodates sub-processes to funnel the encountered exceptions and errors back to higher code levels, check the syntax correctness of the entered arithmetic expressions, be able to monitor the mouse movements and actions while it remains within the data grid.

The grid also contains embedded behaviors and objects models to facilitate the sorting requests, and displays an icon menu bar with record line number display, print, save, copy, cut, paste, add new empty row, and delete existing rows icons all deployed and arranged by the record session software for their associated services.

The record session software in conjunction with the other code components provide seamless operations in total synchronization with the core calculator, copy and paste processes, data storing schemes, and interactions with the data base. The extractable properties associated with selection of data matrix cells as a collection and the states of the control objects associated with the record session status provides the crucial information which software interrogates or updates to perform such functionalities.

DATABASE: The software device database is implemented as a multifaceted database to store computational transactions initiated and stored by the data matrix, core calculator transactions history, and the core calculator operator control buttons which get set dynamically by the user to perform varied computational tasks.

The software is linked to the database components by the use of a dataset object containing the subclasses and components to both provide data storage and caching mechanisms autonomously, and to connect the software clients with the database via dedicated bidirectional binding methods. As a result the dataset is configured to implement data validation constraints if required, and to halt and provide signals to the client fault handler if an interaction is erroneous.

FAULT AND EXCEPTION HANDLER: Fault and exception handling is divided into two separate classes, first to handle the errors initiated due to computational errors and the improper data feeds and entries. The second class relies on the available computer resources to detect their failures to operate accordingly, which are exceptions generated during the runtime demanding correction by the platform, or in most severe cases require reinstallation of the software device. The former is referred to by the terms fault or exception, and the letter only by the term exception.

The software device has utilized the string resources and localization features to exhibit and record exception and fault descriptions. The description is directly conveyed to the user via popup windows, or logged and recorded. Additional steps to halt the program execution or to provide the user with the exception description are performed as well, which they could lead to resumption of program operation, or to ask the user to exit.

Regarding the fault handler, software via the use of different operator classes and dedicated object methods checks for the errorless operation completion. In the case of error detection during arithmetic operations, the fault handling sub processes examine the error cause with emphasis on null entries, operator errors, or syntax errors.

The fault handling threads provides visual indicators such as change of entries, resin and data matrix cells fore and background colors, when a fault is detected. This only affects the error entered sources, which independent correction to each removes the alarm conditions and provides a mechanism to isolate the errors and to remove them through visual graphical steps.

The entries or computational errors would result in immediate removal of the correlated result fields to only be repopulated with the correct result values after the error removal of their associated entities is completed.

CALCULATION ENGINE: The software device is architected by a multilayer software paradigm, and utilizes core computational server components to be deployed accordingly based on the operation type. As a result each core calculator operator and its dynamically set group members is serviced by a distinct object method where the computational patterns and their likely occurring errors are predictable. This makes such error handlers more customized and adaptable to a predictable error pattern.

The computational objects are accordingly invoked by the upper level client components via a top layer interface, when the entries, result, and the selected operator objects are passed to the calculation engine. The engine by examining the entries and their compliance with the applicable constraints proceeds with the selection of the object methods to perform the calculation. Then the attained result or in the case of encountering computational error, the error is conveyed back to the service requester via the control objects and the interface return, which concludes the cycle and provides the requested service.

What is claimed is:

1. A software device to perform math calculations by deploying numerical or data expressions comprised of varied methods; namely the device is capable of, coordinating multiple data entries, displays, and storage operations; the device is comprised of dual entry inputs, a single result display, single arithmetic calculation/expression display for each entry, operation description within result display, and a data spreadsheet matrix which is constantly synchronized with data entries and result contents; the data matrix is capable of operating autonomously when each row performs as a full computational entity, to provide and exhibit results on the fly and as soon as the row entry cells are populated, the data/arithmetic inputs are inserted by the use of the comprised software device control buttons, computer keyboard, software device memory buttons, saved user prior transaction files, the software device entry/result history buttons, undo/redo buttons, or a cut and paste process taken place within the various package displays or external software tools such as Microsoft Office Word and Excel; the software device is comprised of error checking schemes for any type of the above mentioned entry methods in combination with its operation merit monitoring schemes, all contained by and embedded within the device, FIGS. 1 through 21.

2. The software device of claim 1, wherein, providing calculation results by deploying the numerical data and/or arithmetic expressions entered in the two comprised entry text boxes; when the contained data and/or expression entries are inserted via numerical/operator entry buttons, the user entered data history displays, memory buttons, the data matrix, or the software device host platform keyboard, FIGS. 1 and 2.

3. The software device of claim 1, wherein, providing individual calculation results to arithmetic expressions entered within the two comprised entry boxes while each is getting populated in real-time, when a result description is accordingly exhibited within the result display after completion of a calculation; in which entry errors cause the affected entry or result display box fore and background colors to change, and only be cleared by having the error removed; error occurrences would also result in removal of the affected text boxes' result/description entities, and for them to be displayed spontaneously by removal of the error, all contained by the device, FIGS. 1 and 2.

4. The software device of claim 1, wherein, comprised of mathematical operators via a control panel enabling the user of depicting an operator group to navigate and select the operator of interest; dynamic operator control buttons customize the calculation types performed on the entries or result text boxes, which encompasses, squares operator, square root operator, inverse operator, absolute value operator, power operator, remainder operator, percentage operator; each to operate on entries, result, combination, and their inverse operands; all confined within the “Core Calculator” group and selectable by the user as desired; the group when utilized will insert entities within the entry boxes or the data matrix, or set the calculation types to be performed on the entries or result text boxes FIGS. 3 to 9.

5. The software device of claim 1, wherein, comprised of dynamic operator control buttons which all embed a flashing arrow to remind the user of the additional available operators, displayable via a dropdown list. The flashing remains active for a limited time duration and while the mouse is hovering within the control button surface prior to display of the dropdown list, FIGS. 3 through 9.

6. The software device of claim 1, wherein, comprised of data piping control buttons to have the result display content be concurrently entered within the selected data entry box, where it provides a sequential calculation process by allowing the user only to enter a single data or arithmetic expression, in addition the device is comprised of the mechanism to segment arithmetic entries via Core Calculator parentheses control buttons within the entered expressions, FIGS. 1 and 2.

7. The software device of claim 1, wherein, comprised of the entries and result text boxes with dropdown lists enabling selection of a prior entered or result entity within each box, and a method to view and scroll throughout the prior values for each box; in addition to the provided undo and redo control buttons for entries and result text boxes, to make it possible to independently move back and forth throughout the prior entities and refresh the box with a selected value accordingly; combined with comprised entries' clearing control buttons, which are capable of clearing each intended entry box content, FIGS. 1, 2, 10, 11, and 12.

8. The software device of claim 1, wherein, comprised of a group of icon positioning control buttons to move the data insertion point as desired, “Cursor”; the insertion position alterations will take place for both data entry boxes and when data matrix individual cells edit mode is activated; in addition, the device embeds the mechanism to switch to fractional data entries and display formats mode within the entry boxes, or as a part of the entered mathematical expressions, activated via the encompassed Core Calculator fraction control buttons, FIGS. 1 and 2.

9. The software device of claim 1, wherein, comprised of a group of memory control buttons, to enable storage of the result and entry boxes contents, “Memory”; which in addition contains the mechanism to retrieve the stored data in addition to their insertion within the result and entry boxes, via the contained Memory control buttons; where, a group of memory control buttons, are capable of initiating storage or retrieval of entries or/and result displays contents; A flashing line is displayed within the control buttons during the storage or retrieval process, to abandon the process if not completed within a preset timeout period, FIGS. 1, 2, and 20.

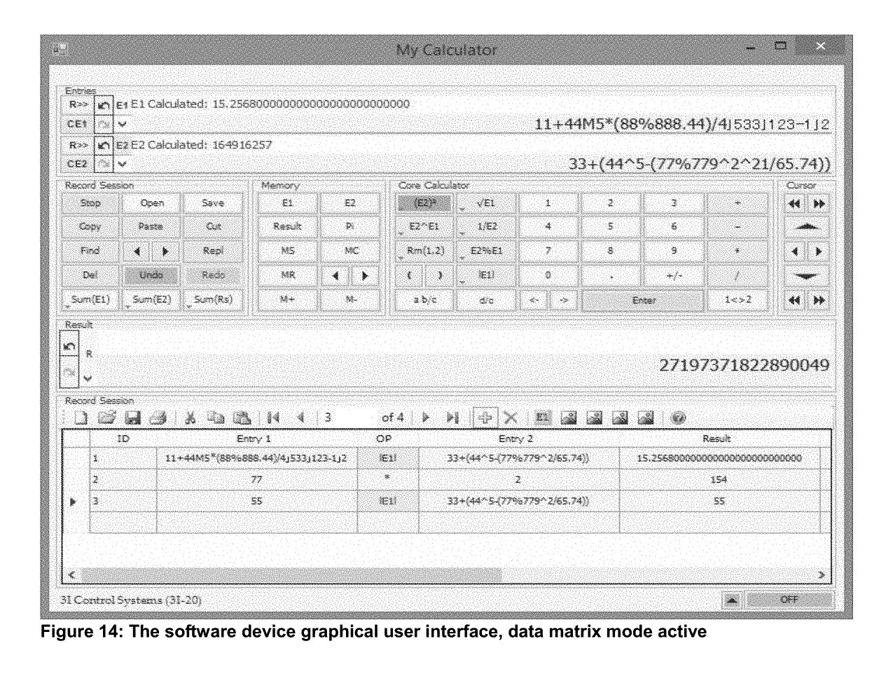

10. A software device comprised of a data matrix entry/calculation grid, if selected so via the “Record Session” group control buttons; to provide synchronization between the entry boxes, result box, and the data matrix elements, if the data matrix mode of operation is enabled by the Record Session group; in addition the device contains the methods to insert numerical data entries or arithmetic expressions within the data matrix individual cells, while the calculation for each individual data matrix row takes place in real time and as soon as the applicable cell entries are completed, FIGS. 13 and 14.

11. The software device of claim 10, wherein, comprised of entry error indication methods for data matrix entries when the affected cell fore and background colors are altered and then cleared when the error is removed in real time; in addition the device contains the mechanism of removing the other affected data matrix row cells contents when an erroneous entry data is intercepted, when row calculations and exhibition of the results resumes in real time as prompt as the errors are removed, and the error indicators for the effected erroneous data matrix cells are cleared simultaneously at the instant that a cell error is corrected, FIGS. 13 and 14.

12. The software device of claim 10, wherein, comprised of control buttons within the Record Session pan& to save or open the session compounded data matrix contents, to enable the software device to store a session via a specially formatted flat file, and to make it available to the user at a later time; in addition to encompass session control buttons enabling the tool to copy, cut, or paste a set of selected data matrix cells within the data matrix, or provide the capability to paste a part of the matrix to external word processing or spreadsheet packages as Microsoft Word or Excel, or paste external tools copied data segments into the data matrix; combined with the scheme to provide background color flashing for the copy or cut selected data matrix cells distinct to the operation type and while a copy or cut session is in progress; the flashing cease to exit either via an elapsed duration timeout or manually by pressing an applicable keyboard button, FIGS. 13, 14, and 15.

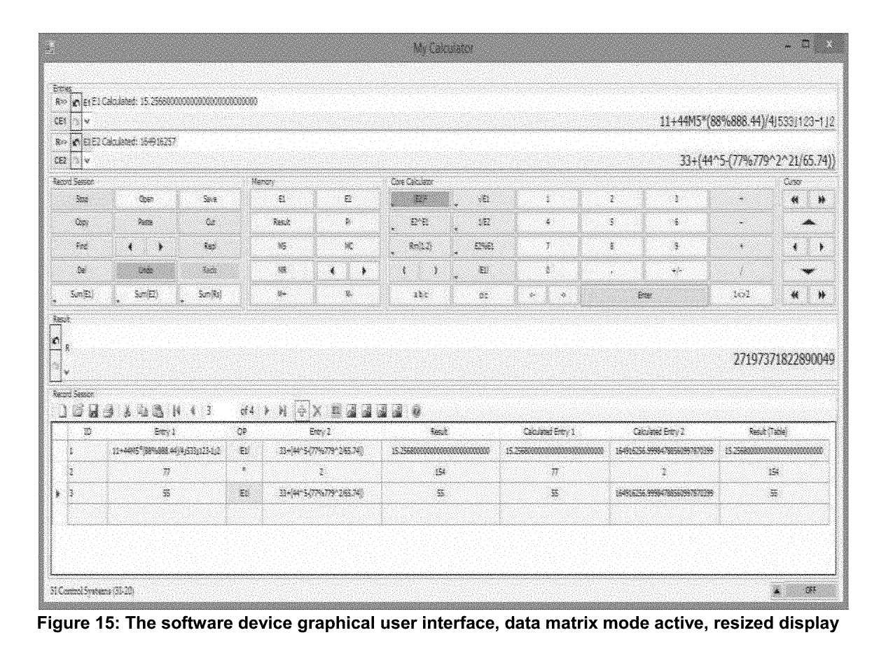

13. The software device of claim 10, wherein, to contain the capability to find or replace data patterns within the data matrix cells, via the Record Session panel control buttons; in addition to be comprised of both data matrix rows and cell content delete buttons during a data matrix open session; combined with a set of redo and undo control buttons within the Record Session panel to navigate throughout the data matrix entries for data manipulations or reset, FIG. 15.

14. The software device of claim 10, comprised of a set of dynamically alterable control buttons; to perform sorting of the data matrix entries or result columns, to calculate the summation values of the data matrix entries or result columns, to calculate the average values of the data matrix entries or result columns, to depict the maximum values of the data matrix entries or result columns, to depict the minimum values of the data matrix entries or result columns, to calculate the deviation values of the data matrix entries or result columns, and to calculate the variance values of the data matrix entries or result columns, FIGS. 16 to 18.

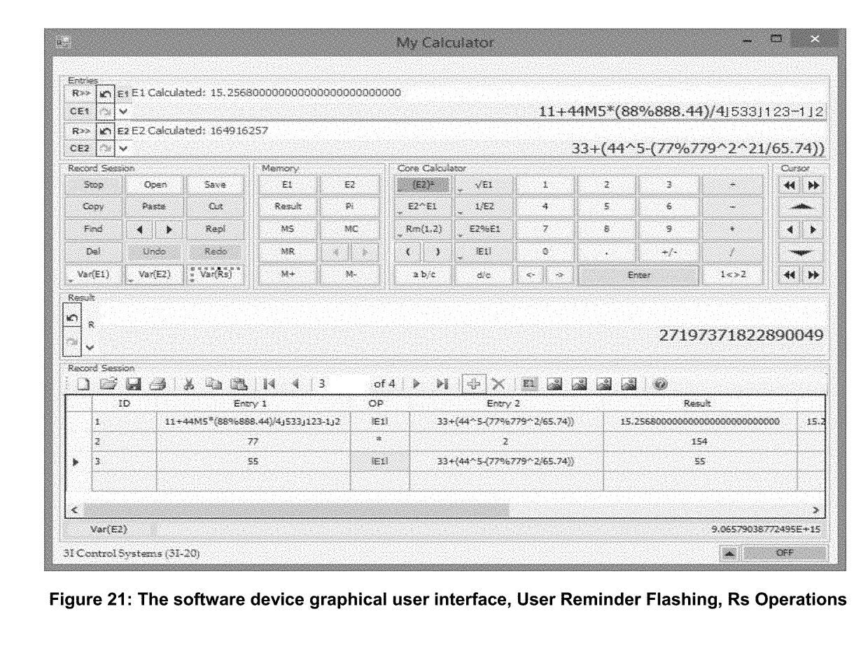

15. The software device of claim 10, wherein, comprised of a flashing arrow displayed within the Record Session applicable control button to remind the user of the additional calculation options embedded within the controls, which if selected all are associated with a to be shown display field; the display field to contain the methods of showing the calculated values for the operations enlisted via claim 14, and removable by the user when desired; in addition, the display field encompasses the schemes to dynamically configure the display field content to retain prior displayed values or be refreshed at completion of alterations to the data matrix entries, selectable by a context menu, FIG. 21.

16. The software device of claim 10, wherein, comprised of the methods to temporarily halt data matrix operations and close its grid by clicking on the arrow control button located at the lower right corner of the device user interface, next to the OFF control button, when closing the data matrix preserves the session with the cell entries intact, only to resume operation when the data matrix is exhibited by the following mouse click on the arrow control button; to remind the user and during the time of data matrix inhibition, record session start control button depicts an altered color while the data matrix is inhibited, FIG. 21.

17. The software device is comprised of the feature to set the device graphical user interface to any desired width if a data matrix entry session is not started or both width and height during a data matrix entry session; embedding the methods to resize the package user interface size by having the mouse cursor placed on the package boundaries, then the device graphical user interface can be stretched out or in by the movement of the mouse and while a mouse button is held down; in addition the device contains the capability to maximize its graphical user interface within the monitor display area, either via the conventional minimize maximize buttons placed at the top right corner of the display, or by double clicking within the title bar, FIG. 21.

18. The software device of claim 17, wherein, comprised of the methods to reflect the device states and settings by the depicted distinct colors of the control buttons, dynamically changing and functionally related to the imposed device operational settings or states, to accordingly altering during the course of the device operation.

19. The software device of claim 17, wherein, comprised of the capability to exit either via the conventional stop button placed at the top right corner of the display, or the OFF control button located at the display bottom right corner, FIG. 21
